(19) United States
(12) Patent Application Publication
(10) Pub. No.: US 2023/0048922 A1
(43) Pub. Date: Feb. 16, 2023

(54) SEMICONDUCTOR DEVICE AND METHOD FOR GENERATING RANDOM NUMBER

(71) Applicant: RENESAS ELECTRONICS CORPORATION, Tokyo (JP)

(72) Inventor: Yuki MORI, Tokyo (JP)

(21) Appl. No.: 17/858,538

(22) Filed: Jul. 6, 2022

(30) Foreign Application Priority Data
Aug. 10, 2021 (JP) 2021-130994

(51) Int. Cl. G06F 21/60; G06F 21/79; G06F 7/58

(52) U.S. Cl. CPC G06F 21/602; G06F 21/79; G06F 7/582

(57) ABSTRACT

A semiconductor device includes a first control unit, a second control unit, a random number generator, a first memory in which random numbers generated by the random number generator are stored, an encryption engine configured to perform encryption and decryption processes by using the random numbers stored in the first memory, and a second memory in which information related to random number generation is stored. The second control unit is configured to generate the random numbers by the random number generator based on the information related to random number generation.

### CROSS-REFERENCE TO RELATED APPLICATIONS

The disclosure of Japanese Patent Application No. 2021-130994 filed on Aug. 10, 2021 including the specification, drawings and abstract is incorporated herein by reference in its entirety.

### BACKGROUND

This disclosure relates to a semiconductor device and can be applied to, for example, a semiconductor device having a security function.

In recent years, in the field of the ECU (Electronic Control Unit) which is an example of a semiconductor device, the importance of security requirements for preventing a threat by a malicious third party has been increasing in the communication between ECUs.

There are disclosed techniques listed below.
[Patent Document 1] Japanese Unexamined Patent Application Publication No. 2018-106628

For example, Patent Document 1 discloses a semiconductor device configured as a secure IP (Intellectual Property) equipped microcontroller for automotive ECU. The semiconductor device has a CPU (Central Processing Unit) and a secure IP. The secure IP provides the CPU with a security function by using the hardware resources managed by itself in response to the process request from the CPU. Examples of the hardware resources include an encryption engine, a random number generator, and the like.

### SUMMARY

In general, a predetermined random number amount generated by a random number generator is consumed each time the secure IP uses the random numbers, and it is necessary to regenerate the random numbers when the generated random numbers are exhausted. If the secure IP requests the random number generator to generate the random number after receiving a request for encryption process from the CPU, it takes time to complete the encryption process using the random number.

Other problems and novel features will be apparent from the description of this specification and accompanying drawings.

An outline of the typical embodiment in this disclosure will be briefly described as follows. That is, a semiconductor device includes a first control unit, a second control unit, a random number generator, a first memory in which random numbers generated by the random number generator are stored, an encryption engine configured to perform encryption and decryption processes by using the random numbers stored in the first memory, and a second memory in which information related to random number generation is stored. The second control unit is configured to generate the random numbers by the random number generator based on the information related to random number generation.

### BRIEF DESCRIPTION OF THE DRAWINGS

FIG. 1 is a block diagram showing the concept of communication between two semiconductor devices according to the embodiment.

FIG. 2 is a block diagram showing the configuration of the semiconductor device according to the embodiment.

FIG. 3 is a block diagram showing the configuration of the secure IP shown in FIG. 1.

FIG. 4 is a functional block diagram showing the process of the secure CPU of the secure IP shown in FIG. 2.

FIG. 5 is a sequence diagram showing a flow of storing information related to random number generation in a data flash.

FIG. 6 is a sequence diagram showing a flow of the process of the semiconductor device in the first example.

FIG. 7 is a sequence diagram showing a flow of the process of the semiconductor device in the comparative example.

FIG. 8 is a sequence diagram showing a flow of the process of the semiconductor device in the second example.

FIG. 9 is a sequence diagram showing a flow of the process of the semiconductor device in the third example.

FIG. 10 is an image diagram showing an example of transition of the random number amount in a random number holding region in the third example.

FIG. 11 is an image diagram showing an example of transition of the random number amount in the first case of the assumed operation of the CPU.

FIG. 12 is an image diagram showing an example of transition of the random number amount in the second case of the assumed operation of the CPU.

FIG. 13 is an image diagram showing an example of transition of the random number amount in the third case of the assumed operation of the CPU.

### DETAILED DESCRIPTION

Hereinafter, the embodiment, the examples, and the modifications will be described with reference to drawings. However, in the following description, the same components are denoted by the same reference characters and the repetitive description thereof will be omitted in some cases.

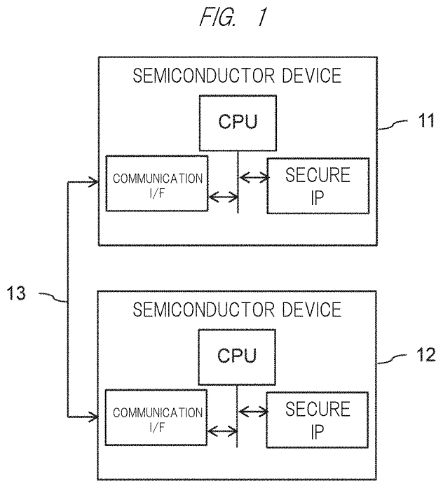

The communication between two semiconductor devices according to the embodiment will be described with reference to FIG. 1.

A semiconductor device 11 and a semiconductor device 12 are connected by a signal line 13, and can mutually perform data communication. Then, the semiconductor device 11 and the semiconductor device 12 are configured to be able to encrypt and decrypt the data to be communicated by using a common key held in advance by both of them by using a predetermined encryption processing algorithm. Further, the semiconductor device 11 and the semiconductor device 12 are configured to have the same function, and the transmitting side and the receiving side can be mutually exchanged therebetween.

Specifically, the semiconductor device 11 and the semiconductor device 12 can be configured as microcontrollers equipped with secure IP (Intellectual Property) for automotive ECU. The semiconductor device 11 and the semiconductor device 12 may be mounted on the same automobile or different automobiles. Further, each of the semiconductor device 11 and the semiconductor device 12 may be referred to also as a semiconductor chip.

For example, the semiconductor device 11 creates a ciphertext by encrypting a plain text to be sent and a random number by use of the common key. Thereafter, the semiconductor device 11 sends the ciphertext to the semiconductor device 12. The semiconductor device 12 acquires the plain text and the random number by decrypting the received ciphertext by use of the common key. If the plain text position is shared at the same timing as the common key, the semiconductor device 12 can extract only the plain text that the semiconductor device 11 wants to send, from the decryption result.

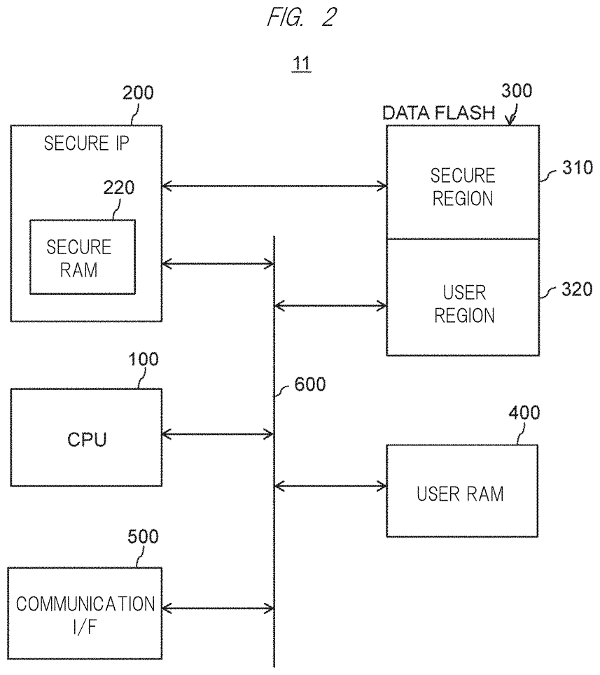

The semiconductor device 11 according to the embodiment will be described with reference to FIG. 2.

The semiconductor device 11 includes a CPU 100, a secure IP 200, a data flash 300, a user RAM 400, and a communication interface (I/F) 500. In the semiconductor device 11, these elements are connected to each other via a bus 600. The semiconductor device 12 has the same configuration as the semiconductor device 11.

The CPU 100 performs various processes according to the user program (user application). The secure IP 200 performs the security process such as encryption process using random numbers. For example, the CPU 100 requests (instructs) the secure IP 200 to perform security process. Then, when the secure IP 200 receives the instruction from the CPU 100, the secure IP 200 performs the instructed security process.

The secure IP 200 has a secure RAM 220 composed of an SRAM (Static Random Access Memory) which is a volatile memory. The secure RAM 220 as the first memory is a memory that can be accessed from the secure IP 200 but cannot be directly accessed from the CPU 100. The secure IP 200 stores random numbers generated by a random number generator described later in the secure RAM 220. The secure RAM 220 only needs to be accessible from the secure IP 200, and does not necessarily have to be built in the secure IP 200.

The data flash (DATA FLASH) 300 is composed of a flash memory which is a non-volatile memory, and has logically divided secure region 310 and user region 320. The secure region 310 of the data flash 300 as the second memory is a region that can be accessed from the secure IP 200 but cannot be directly accessed from the CPU 100. Note that the secure region 310 may be built in the secure IP 200. The user region 320 can be accessed from both the CPU 100 and the secure IP 200. The secure region 310 stores information related to random number generation used in the secure IP 200 and others. The user region 320 stores, for example, a user program executed by the CPU 100 and data used by the user program. The first control unit is configured by the CPU 100 and the user region 320 of the data flash 300.

The user RAM 400 is a volatile memory, and the CPU 100 uses the user RAM 400 as a workspace when performing various processes or the like. Further, the user RAM 400 is a shared memory between the CPU 100 and the secure IP 200. For example, the CPU 100 stores the target data of the security process requested to the secure IP 200 in the user RAM 400. Further, the secure IP 200 stores the data subjected to the security process in the user RAM 400.

The communication I/F 500 is an interface for communicating with the outside of the semiconductor device 11, for example, the semiconductor device 12 via the signal line 13.

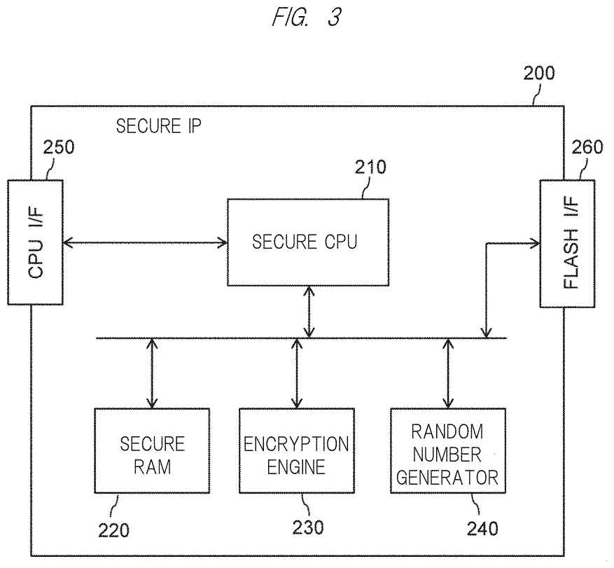

The configuration of the secure IP 200 according to the embodiment will be described with reference to FIG. 3.

The secure IP 200 includes, for example, a secure CPU 210, a secure RAM 220, an encryption engine 230, a random number generator 240, a CPU interface (CPU I/F) 250, and a flash interface (FLASH I/F) 260. The CPU interface 250 is an interface for connecting the secure IP 200 and the CPU 100 (see FIG. 2). For example, the CPU interface 250 has a function of sending an interrupt request to the CPU 100 and a function of receiving an interrupt request from the CPU 100. Further, the flash interface 260 is an interface for connecting the secure IP 200 and the data flash 300.

The secure CPU 210 controls the implementation of various security processes. The encryption engine 230 performs a process related to encryption. The random number generator 240 generates random numbers. The secure CPU 210 performs various security processes including encryption process, decryption process, and random number generation by using the encryption engine 230, the random number generator 240, and others. The secure CPU 210 performs the security process by, for example, reading a program from the secure region 310 of the data flash 300 and executing the program.

The secure CPU 210 communicates with the CPU 100 through the CPU interface 250. The CPU 100 instructs (requests) the secure CPU 210 to store information related to random number generation in the secure region 310 of the data flash 300. When the CPU 100 instructs the secure CPU 210 to store information related to random number generation, the secure CPU 210 accesses the data flash 300 through the flash interface 260 and stores (saves) the designated information related to random number generation in the secure region 310.

Further, the CPU 100 instructs the secure CPU 210 to perform the security process. When the CPU 100 instructs the secure CPU 210 to perform the security process, the secure CPU 210 performs the instructed security process. At that time, the secure CPU 210 performs the random number generation by using the information related to random number generation stored in the secure region 310 of the data flash 300. For example, the instruction to store the information related to random number generation in the secure region 310 of the data flash 300 is given before the secure CPU 210 performs random number generation using the information related to random number generation.

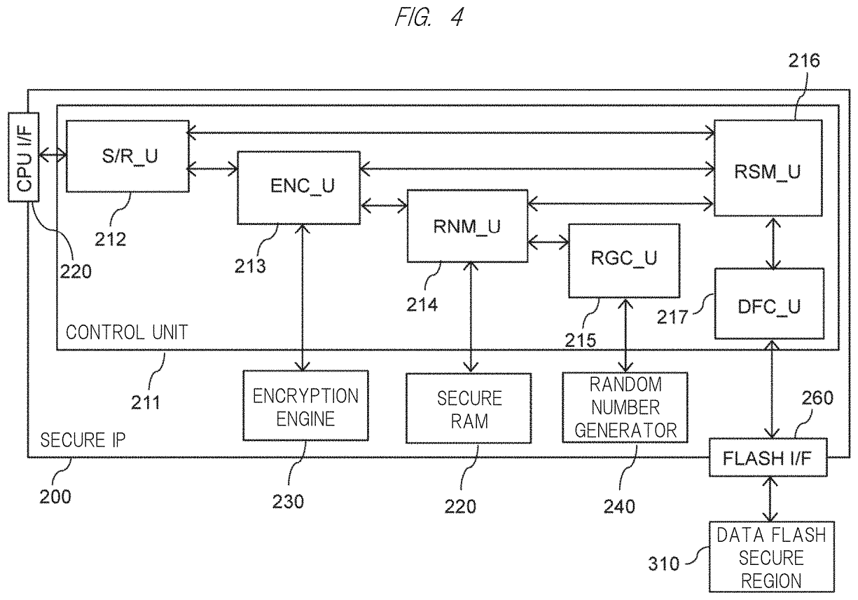

A control unit that executes the function of the secure IP 200 will be described with reference to FIG. 4.

The control unit 211 includes a transmission/reception unit (S/R_U) 212, an encryption processing unit (ENC_U) 213, a random number management unit (RNM_U) 214, a random number generation control unit (RGC_U) 215, a random number generation setting management unit (RSM_U) 216, and a data flash control unit (DFC_U) 217. Here, the control unit 211 as the second control unit has a configuration including the secure CPU 210 and the secure region 310 in which the program executed by the secure CPU 210 is stored. The transmission/reception unit (S/R_U) 212 communicates with the CPU 100. The encryption processing unit (ENC_U) 213 performs encryption process using random numbers (hereinafter, simply referred to as encryption process). The random number management unit (RNM_U) 214 manages the generation of random numbers. The random number generation control unit (RGC_U) 215 controls the random number generator 240. The random number generation setting management unit (RSM_U) 216 manages the setting of the information related to random number generation. The data flash control unit (DFC_U) 217 controls the access to the secure region 310 of the data flash 300.

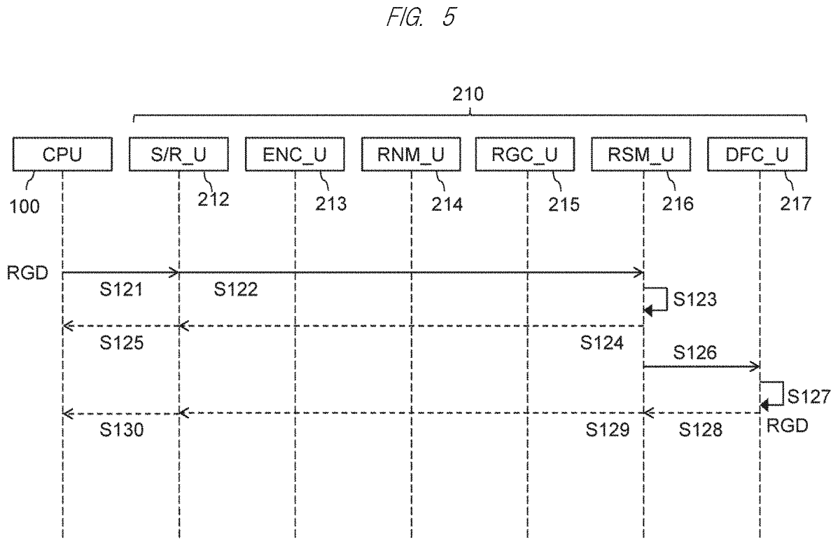

The storage of the information related to random number generation in the data flash will be described with reference to FIG. 5.

The CPU 100 requests the secure CPU 210 to store the information related to random number generation (RGD) in the data flash 300 (step S121). The transmission/reception unit (S/R_U) 212 receives the request from the CPU 100 and requests the random number generation setting management unit (RSM_U) 216 to store the information related to random number generation (step S122).

The random number generation setting management unit (RSM_U) 216 receives the request and performs authentication (step S123). The authentication is performed using, for example, a common key. The encryption engine 230 and the random number generator 240 may be used for the authentication, if necessary.

If the authentication fails, the random number generation setting management unit (RSM_U) 216 ends the process at that point, and notifies the transmission/reception unit (S/R_U) 212 that the authentication has failed (step S124). The transmission/reception unit (S/R_U) 212 receives the notification from the random number generation setting management unit (RSM_U) 216 and notifies the CPU 100 that the authentication has failed (step S125).

If the authentication is successful, the random number generation setting management unit (RSM_U) 216 requests the data flash control unit (DFC_U) 217 to store the information related to random number generation (RGD) in the secure region 310 of the data flash 300 (step S126). The data flash control unit (DFC_U) 217 stores the information related to random number generation (RGD) in the secure region 310 of the data flash 300 (step S127).

When the storage of the information related to random number generation (RGD) is completed, the data flash control unit (DFC_U) 217 notifies the random number generation setting management unit (RSM_U) 216 of the completion of storage (step S128). The random number generation setting management unit (RSM_U) 216 receives the notification from the data flash control unit (DFC_U) 217 and notifies the transmission/reception unit (S/R_U) 212 of the completion of storage (step S129). The transmission/reception unit (S/R_U) 212 receives the notification from the random number generation setting management unit (RSM_U) 216 and notifies the CPU 100 of the completion of storage (step S130).

As to the information related to random number generation (RGD) in the embodiment, the first example, the second example, and the third example will be described below.

### First Example

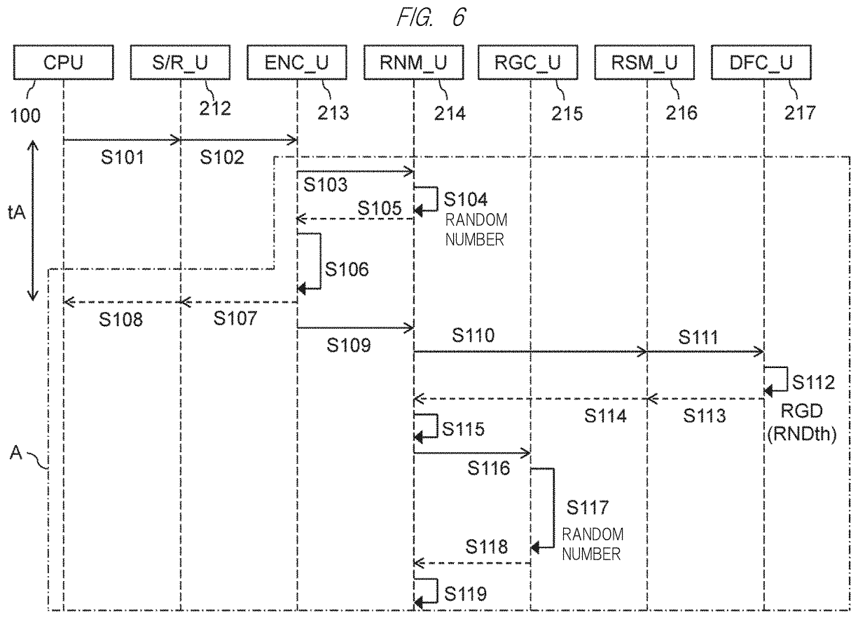

The process of the semiconductor device 11 in the first example will be described with reference to FIG. 6.

The CPU 100 requests the secure CPU 210 to perform the encryption process (step S101). The transmission/reception unit (S/R_U) 212 receives the request from the CPU 100 and requests the encryption processing unit (ENC_U) 213 to perform the process (step S102).

The encryption processing unit (ENC_U) 213 requests the random number management unit (RNM_U) 214 to acquire a random number (step S103). The random number management unit (RNM_U) 214 acquires a random number from the secure RAM 220 (step S104). The random number management unit (RNM_U) 214 returns the random number to the encryption processing unit (ENC_U) 213 (step S105). Here, for the sake of simplifying the description, it is assumed that the random number generation is completed in the random number generator 240 and the random number is stored in the secure RAM 220.

The encryption processing unit (ENC_U) 213 performs the encryption process based on the acquired random number (step S106). The encryption processing unit (ENC_U) 213 operates the encryption engine 230 as needed.

When the encryption process is completed, the encryption processing unit (ENC_U) 213 notifies the transmission/reception unit (S/R_U) 212 of the completion of the process (step S107). The transmission/reception unit (S/R_U) 212 receives the notification from the encryption processing unit (ENC_U) 213 and notifies the CPU 100 of the completion of the process (step S108).

When the encryption process is completed, the encryption processing unit (ENC_U) 213 notifies the random number management unit (RNM_U) 214 of the completion of the encryption process (step S109). When the encryption processing unit (ENC_U) 213 has used the random number stored in the secure RAM 220, the random number management unit (RNM_U) 214 deletes the random number from the secure RAM 220.

The random number management unit (RNM_U) 214 requests the random number generation setting management unit (RSM_U) 216 to acquire the information related to random number generation (RGD) (step S110). The random number generation setting management unit (RSM_U) 216 receives the request from the random number management unit (RNM_U) 214 and requests the data flash control unit (DFC_U) 217 to acquire the information related to random number generation (RGD) (step S111). The data flash control unit (DFC_U) 217 receives the request from the random number generation setting management unit (RSM_U) 216 and reads the information related to random number generation (RGD) from the secure region 310 of the data flash 300 (step S112). The data flash control unit (DFC_U) 217 gives the information related to random number generation (RGD) to the random number generation setting management unit (RSM_U) 216 (step 113). The random number generation setting management unit (RSM_U) 216 returns the information related to random number generation (RGD) to the random number management unit (RNM_U) 214 (step S114). Here, the information related to random number generation (RGD) in the first example is the remaining random number amount (RNDth) at which the random number generation is started.

The random number management unit (RNM_U) 214 determines whether or not random number generation is necessary (step S115). When the encryption processing unit (ENC_U) 213 performs the encryption process using the random number, the random numbers stored in the secure RAM 220 are consumed and the random number amount decreases. The random number management unit (RNM_U) 214 determines whether or not random number generation is necessary by comparing the random number amount (remaining random number amount) stored in the secure RAM 220 with RNDth. When the remaining random number amount is equal to or less than RNDth and it is determined that the random number generation is necessary, the random number management unit (RNM_U) 214 requests the random number generation control unit (RGC_U) 215 to generate random numbers (step S116). The random number generation control unit (RGC_U) 215 generates random numbers by the random number generator 240 (step S117). The random number generation control unit (RGC_U) 215 gives the random numbers generated by the random number generator 240 to the random number management unit (RNM_U) 214 (step S118). The random number management unit (RNM_U) 214 stores the acquired random numbers in the secure RAM 220 (step S119).

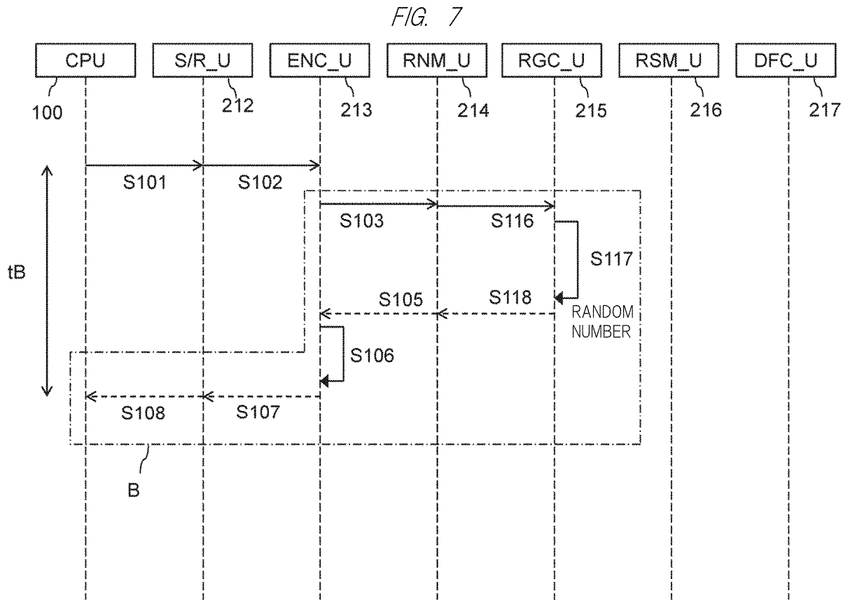

The advantages of the first example will be described with reference to FIG. 6 and FIG. 7.

First, a comparative example will be described in order to clarify the first example. As shown in FIG. 7, in the comparative example, after receiving the request for encryption process from the CPU 100, the secure CPU 210 requests the random number generation.

Namely, the CPU 100 requests the secure CPU 210 to perform the encryption process (step S101). The transmission/reception unit (S/R_U) 212 receives the request from the CPU 100 and requests the encryption processing unit (ENC_U) 213 to perform the process (step S102). The encryption processing unit (ENC_U) 213 receives the request from the transmission/reception unit (S/R_U) 212 and requests the random number management unit (RNM_U) 214 to generate random numbers (step S103). The random number management unit (RNM_U) 214 receives the request from the encryption processing unit (ENC_U) 213 and requests the random number generation control unit (ROC_U) 215 to generate random numbers (step S116).

The random number generation control unit (RGC_U) 215 generates random numbers by the random number generator 240 (step S117). The random number generation control unit (RGC_U) 215 gives the random numbers generated by the random number generator 240 to the random number management unit (RNM_U) 214 (step S118). The random number management unit (RNM_U) 214 returns the random number to the encryption processing unit (ENC_U) 213 (step S105).

On the other hand, in the first example, as described above, after the encryption process, the secure CPU 210 determines whether to generate random numbers, and starts the random number generation as necessary. Namely, as shown in FIG. 6, after the step S106, the random number management unit (RNM_U) 214 determines whether or not random number generation is necessary (step S115), and when it is determined that the random number generation is necessary, the random number management unit (RNM_U) 214 requests the random number generation control unit (RGC_U) 215 to generate random numbers (step S116).

When the secure CPU 210 requests the random number generator 240 to generate random numbers without waiting for the request for random number generation from the CPU 100, the random number generation is started in advance when viewed from the CPU 100. Therefore, the time until the completion of the encryption process requested by the CPU 100 (the time from the start of step S101 to the end of step S108) can be shortened. Assuming that the time from the start of step S101 to the end of step S108 shown in FIG. 6 is tA and the time from the start of step S101 to the end of step S107 shown in FIG. 7 is tB, tA is shorter than tB (tA<tB).

### Second Example

Next, the second example will be described. In the second example, the secure IP 200 stores trigger data (TRG) indicating which of the secure CPU 210 or the CPU 100 requests the start of random number generation, in the secure region 310 of the data flash 300.

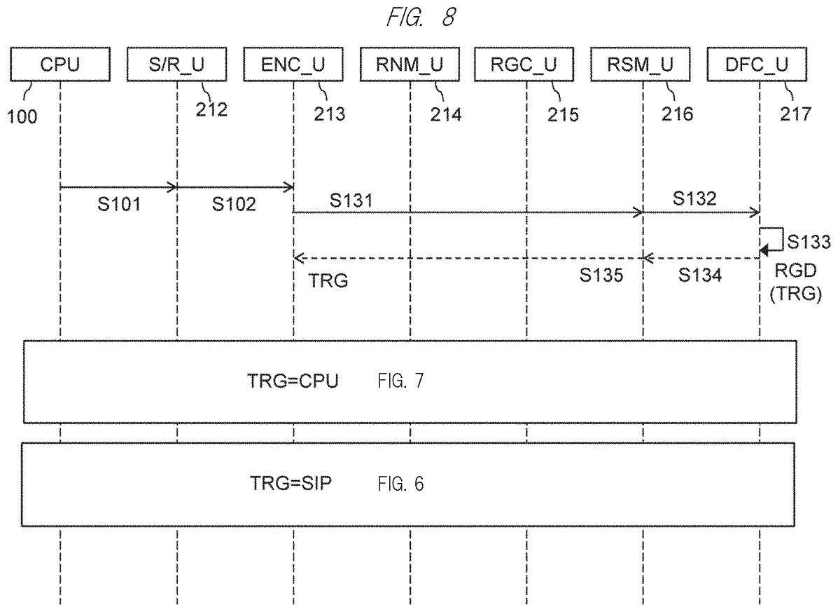

The process of the semiconductor device in the second example will be described with reference to FIG. 8.

In the secure IP 200 in the second example, it is possible to select whether the secure CPU 210 determines and requests the random number generation to the random number generator 240 or the random number generation is performed after waiting for the request from the CPU 100. Namely, the secure IP 200 is configured so as to be able to select the operation of the first example and the operation of the comparative example. The trigger data (TRG) indicating which of the secure CPU 210 or the CPU 100 requests the start of random number generation is stored in the secure region 310 of the data flash 300. The secure CPU 210 reads the trigger data (TRG) from the secure region 310 of the data flash 300, and starts the random number generation in accordance with the trigger data (TRG). Here, the trigger data (TRG) is the information related to random number generation (RGD). The trigger data (TRG) is stored in the secure region 310 of the data flash 300 by the sequence shown in FIG. 5.

As to the process of the semiconductor device in the second example, the difference from the first example will be mainly described below. Steps S101 and S102 in the second example are the same as steps S101 and S102 in the first example.

In the second example, at the start of the encryption process, the encryption processing unit (ENC_U) 213 reads the trigger data (TRG) from the secure region 310 of the data flash 300 via the random number generation setting management unit (RSM_U) 216 and the data flash control unit (DFC_U) 217. Consequently, the trigger data (TRG) is set.

Namely, the encryption processing unit (ENC_U) 213 requests the random number generation setting management unit (RSM_U) 216 to acquire the trigger data (TRG) (step S131). The random number generation setting management unit (RSM_U) 216 receives the request from the encryption processing unit (ENC_U) 213 and requests the data flash control unit (DFC_U) 217 to acquire the trigger data (TRG) (step S132). The data flash control unit (DFC_U) 217 receives the request from the random number generation setting management unit (RSM_U) 216 and reads the trigger data (TRG) from the secure region 310 of the data flash 300 (step S133). The data flash control unit (DFC_U) 217 gives the trigger data (TRG) to the random number generation setting management unit (RSM_U) 216 (step S134). The random number generation setting management unit (RSM_U) 216 receives the trigger data (TRG) and gives the trigger data (TRG) to the encryption processing unit (ENC_U) 213 (step S135).

When the trigger data (TRG) indicates that the CPU 100 makes a request for random number generation (TRG=CPU), the secure CPU 210 performs the process in accordance with the sequence shown by the alternate long and short dash line B in FIG. 7. When the trigger data (TRG) indicates that the secure CPU 210 makes a request for random number generation (TRG=SIP), the secure CPU 210 performs the process in accordance with the sequence shown by the alternate long and short dash line A in FIG. 6.

The comparative example of the first example has the problem that it takes time to complete the encryption process. On the other hand, since the random number generation is started in the encryption process, the time until the encryption process is completed is constant when viewed from the CPU 100. When the response performance of the function is constant as described above, the design of the application that uses the function can be facilitated.

In the first example, the secure CPU 210 determines and requests the random number generation, and thus the completion time of the encryption process viewed from the CPU 100 changes depending on the progress of the random number generation by the random number generator 240. Namely, when the CPU 100 makes the request for encryption process during the random number generation by the random number generator 240, if the generated random numbers are less than the random numbers required for the encryption process, the encryption process is not started until the random number generator completes the generation of random numbers. Accordingly, the processing time differs depending on the timing at which the CPU 100 requests the encryption process. Therefore, the completion time of the encryption process may change unintentionally when viewed from the CPU 100. On the other hand, when the secure CPU 210 requests the random number generator 240 to generate random numbers without waiting for the request for random number generation from the CPU 100, the random number generation can be started in advance when viewed from the CPU 100. It is possible to shorten the time required to complete the encryption process requested by the CPU 100.

In the case of the CPU 100 assuming the system in which the case where the response time of the encryption process is not constant is regarded as abnormal, the user selects the CPU 100 as a requester (trigger) for random number generation. Further, in the case of the CPU 100 assuming the system in which the response as fast as possible is expected with no regard for the constant response time of the encryption process, the user selects the secure CPU 210 as a requester for random number generation. Namely, in the second example, the CPU 100 can set the trigger for starting the random number generation to the random number generator 240. As a result, the user can select which of the above-mentioned advantage and disadvantage is allowed for the completion time of the encryption process depending on the situation.

### Third Example

Next, the third example will be described. In the third example, the CPU 100 is configured to be able to set the size of the region reserved for holding random numbers in the secure RAM 220 of the secure IP 200 and the remaining random number amount at which the random number generation is started. In the first example, the processing time unintentionally changes in relation to the time until random number generation, the consumption amount, and the frequency of process requests. This is because the threshold value (RNDth) for determining whether to start the random number generation alone cannot cope with the case where encryption processes using random numbers are sequentially requested in a short time. The operation time of the random number generator 240 is generally 10 times or more longer than that of the encryption process. Accordingly, when the encryption processes are sequentially requested in a short time, it is necessary to hold random numbers in the secure RAM 220 and consume them from there. Therefore, it is necessary to be make it possible to set not only the RNDth but also the size of the region reserved for holding random numbers in the secure RAM 220.

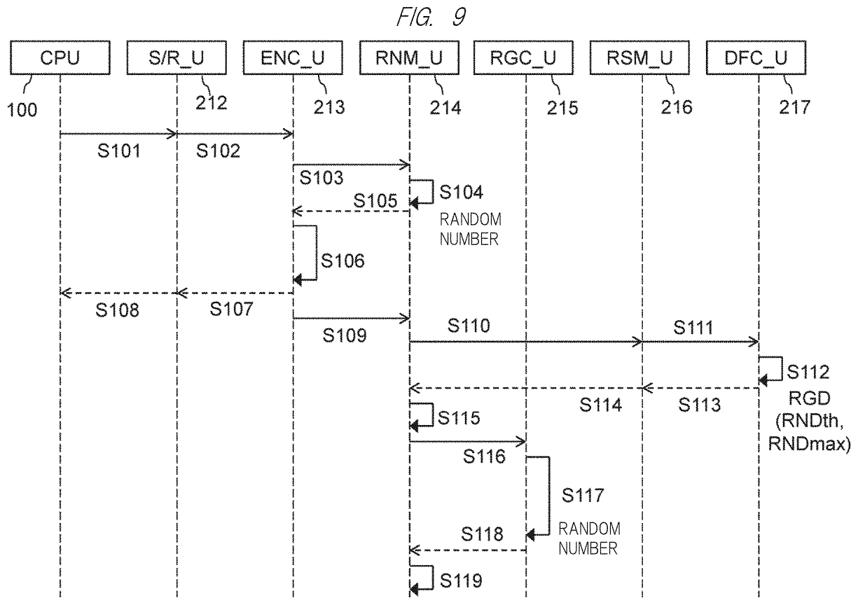

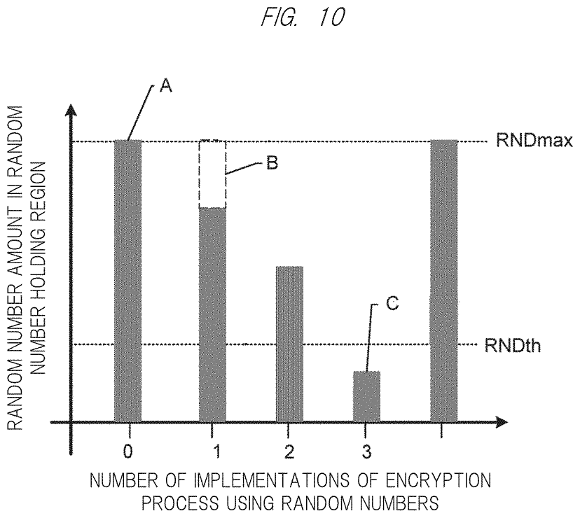

The process of the semiconductor device in the third example will be described with reference to FIG. 9 and FIG. 10.

The secure CPU 210 is configured to be able to set the frequency of triggering random number generation and the operation time of the random number generator 240, to the random number generator 240. Namely, the CPU 100 can set the size of the region reserved for holding random numbers in the secure RAM 220 (RNDmax) and the remaining random number amount (RNDth) at which the random number generation is started, which are fixed in the first example. Here, RNDmax and RNDth are the information related to random number generation (RGD). The procedure for storing the information related to random number generation (RGD) in the secure region 310 of the data flash 300 is the same sequence as that in FIG. 5 of the first example.

As to the process of the semiconductor device in the third example, the difference from the first example will be mainly described below. Steps S101 to S119 in the third example are the same as steps S101 to S119 in the first example. However, there is a difference in the information related to random number generation (ROD) stored in the secure region 310 of the data flash 300.

The random number management unit (RNM_U) 214 determines whether or not random number generation is necessary (step S115). When the random number management unit (RNM_U) 214 determines that the random number amount (remaining random number amount) stored in the secure RAM 220 is equal to or less than RNDth and the random number generation is necessary, the random number management unit (RNM_U) 214 requests the random number generation control unit (RGC_U) 215 to generate random numbers (step S116). The random number generation control unit (RGC_U) 215 generates the random numbers by the random number generator 240 (step S117). The random number generation control unit (RGC_U) 215 gives the random numbers generated by the random number generator 240 to the random number management unit (RNM_U) 214 (step S118). The random number management unit (RNM_U) stores the acquired random numbers in the secure RAM 220 (step S119).

As described above, the information related to random number generation (RGD) that can be set and changed by the CPU 100 is RNDmax and RNDth. Then, the CPU 100 can control the timing at which the secure CPU 210 requests random number generation and the operation time of the random number generator 240 by changing the set values of RNDmax and RNDth.

At this time, the number of implementations of the encryption process using random numbers and the random number amount in the random number holding region are presented as shown in FIG. 10. As shown in FIG. 10, the state A is a state in which the random number generator 240 has completed the random number generation, and the random number amount in the random number holding region of the secure RAM 220 is RNDmax. The state B is a state in which random numbers are acquired (consumed) by encryption process, and the random number amount in the random number holding region of the secure RAM 220 is smaller than RNDmax. The state C is a state in which the random number amount in the random number holding region of the secure RAM 220 is equal to or less than RNDth, and the random number management unit (RNM_U) 214 requests the random number generator 240 to generate random numbers.

The third example solves the problem of the first example that the completion time of the encryption process using random numbers may change unintentionally when viewed from the CPU 100, by the method different from that of the second example. In the third example, the CPU 100 sets the frequency and time of the operation of the random number generator 240, and the secure CPU 210 determines whether to operate the random number generator 240 based on the setting. In other words, the CPU 100 can prepare the random numbers by the setting when necessary, and the encryption process can be performed without being kept waiting by the random number generator 240.

In the third example, the CPU 100 can set the conditions in which the secure CPU 210 operates the random number generator, so that the secure CPU 210 can provide the encryption process to the CPU 100 in the optimum time for the CPU 100.

The method of selecting the setting of random number generation for the user of the CPU 100 and the criteria for selecting the setting of RNDmax and RNDth assumed in the process of the CPU 100 in the third example will be described below.

Other parameters assumed in the process of the CPU 100 are as follows.

Random number amount used in one encryption process: RNDdelta

Time of the section in which encryption processes are sequentially requested (RQS): Treq

Time of the section in which encryption process is not requested (NQS): Tnreq

Interval of cycles to request the process in the section in which encryption processes are sequentially requested: Tperi

Time in which the random number generator 240 generates random numbers for RNDdelta: Trnddelta

At this time, the condition for preventing the exhaustion of the random numbers in the section in which the encryption processes are requested (RQS) is expressed by the following equation (1).

Treq/Tperi*RNDdelta<RNDmax (1)

The condition for not operating the random number generator 240 in the section in which the encryption processes are requested (RQS) is expressed by the following equation (2).

Treq/Tperi*RNDdelta<(RNDmax−RNDth) (2)

The values of Treq, Tnreq, and Tperi are determined by the operation assumed in the process of the CPU 100. The value of Trnddelta is determined by the performance of the random number generator 240 of the secure IP 200. In this way, the set values of RNDmax and RNDth can be determined from the operation assumed in the process of the CPU 100.

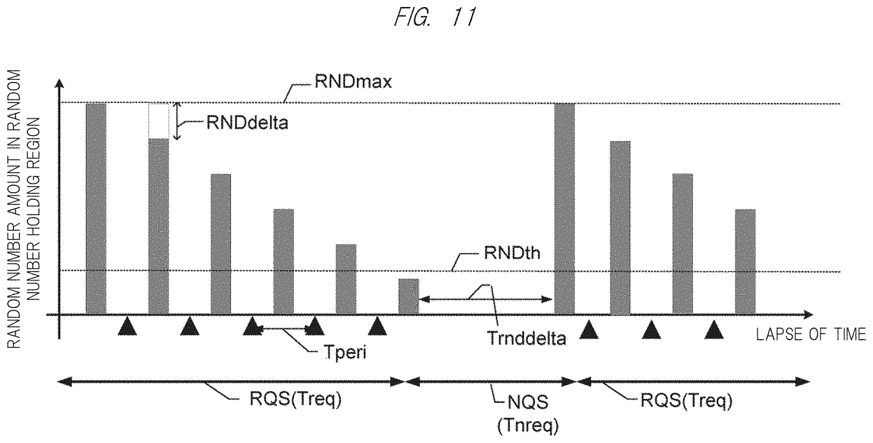

Next, three types of cases are assumed for the process of the CPU 100, and setting examples for each case will be described with reference to FIG. 11 to FIG. 13. The black triangles (▴) shown in FIG. 11 to FIG. 13 indicate the timing at which the encryption process using random numbers is performed.

(First Case)

As shown in FIG. 11, the process of the CPU 100 in the first case assumes that the section in which the encryption processes are requested (RQS) and the section in which the encryption process is not requested (NQS) come alternately.

The condition for not operating the random number generator 240 and preventing the exhaustion of the random numbers in the section in which the encryption processes are requested (RQS) is expressed by the equation (2) mentioned above.

The condition for completing the random number generation in the section in which the encryption process is not requested (NQS) is expressed by the following equation (3).

Trnddelta*(Treq/Tperi*RNDdelta)<Tnreq (3)

By adjusting RNDmax and RNDth so as to satisfy the conditions of the equations (2) and (3), the CPU 100 can perform the encryption process without waiting for the random number generation time. Further, since the equation (3) is a relational expression between the performance of random number generation and the frequency of process requests, it is used to determine whether the performance of the secure IP 200 can satisfy the processing assumption of the CPU 100.

(Second Case)

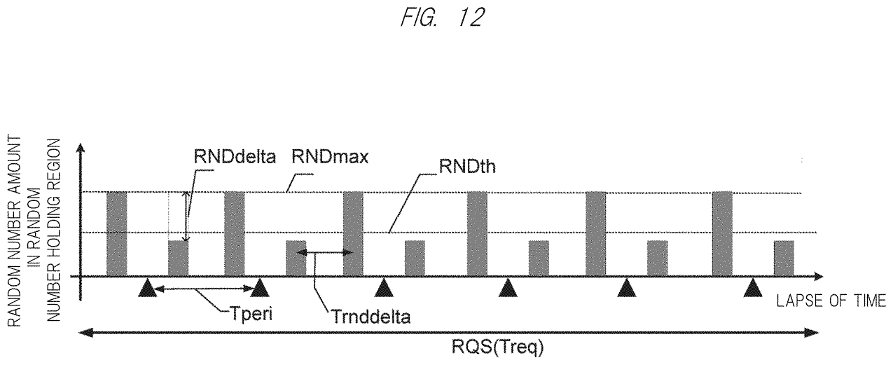

Next, as shown in FIG. 12, the process of the CPU 100 in the second case assumes that the section in which the encryption processes are requested (RQS) continues for the entire period. Since the requests of encryption process continue endlessly, it is necessary to generate random numbers in the interval between the requests of encryption process (Tperi).

The condition for securing the random number amount used in the encryption process needs to satisfy the following equation (4).

RNDmax>RNDdelta (4)

The number of requests for encryption process until random number generation is performed is expressed by the following equation (5). In FIG. 12, the number of requests is represented as 1.

(RNDmax−RNDth)/RNDdelta (5)

Since it is necessary to generate random numbers in the interval between the requests of encryption process (Tperi), the condition of the following equation (6) is derived from the equation (5).

Trnddelta*(RNDmax−RNDth)/RNDdelta<Tperi (6)

By adjusting RNDmax and RNDth under the condition satisfying the equations (4) and (6), the CPU 100 can perform the encryption process without waiting for the random number generation time. Further, since the equations (4) and (6) include the performance of random number generation and the frequency of process requests, whether or not the performance of the secure IP 200 can satisfy the processing assumption of the CPU 100 is also determined together.

(Third Case)

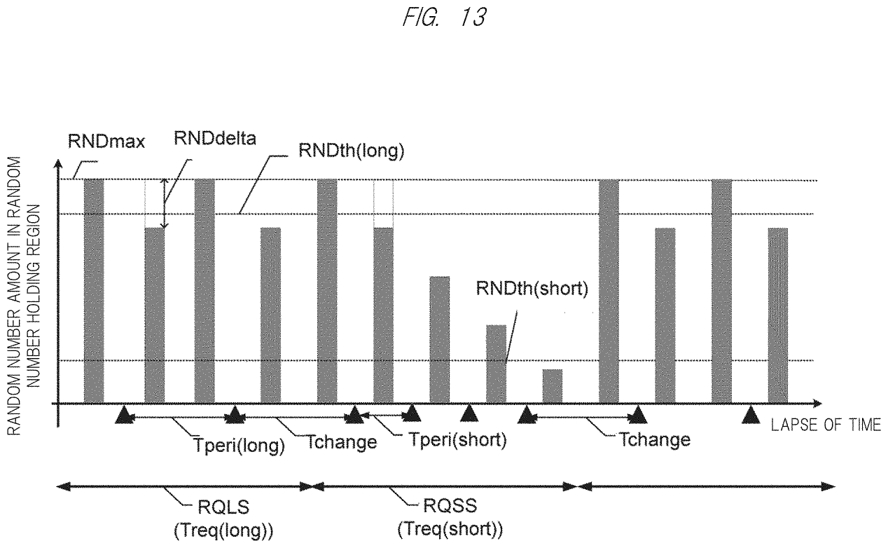

Finally, as shown in FIG. 13, the process of the CPU 100 in the third case assumes that the section in which the encryption processes are requested at long intervals (RQLS) and the section in which the encryption processes are requested at short intervals (RQSS) come alternately.

The time of the section in which the encryption processes are requested at long intervals (RQLS) is defined as Treq(long), and the time of the section in which the encryption processes are requested at short intervals (RQSS) is defined as Treq(short). The intervals between the requests of encryption process in these sections are defined as Tperi(long) and Tperi(short), respectively.

Also, RNDth is set and changed for each of the section in which the encryption processes are requested at long intervals (RQLS) and the section in which the encryption processes are requested at short intervals (RQSS). The remaining random number amount at which the random number generation is started in the section in which the encryption processes are requested at long intervals (RQLS) is defined as RNDth(long). Further, the remaining random number amount at which the random number generation is started in the section in which the encryption processes are requested at short intervals (RQSS) is defined as RNDth(short). The changing time between the section in which the encryption processes are requested at long intervals (RQLS) and the section in which the encryption processes are requested at short intervals (RQSS) is defined as Tchange. Tchange is the time from the last process request in the section in which the encryption processes are requested at long intervals (RQLS) to the first process request in the section in which the encryption processes are requested at short intervals (RQSS) and the time from the last process request in the section RQSS to the first process request in the section RQLS.

The conditions to be satisfied by RNDmax and RNDth in the section in which the encryption processes are requested at long intervals (RQLS) are the same as those of the equations (4) and (6) in the second case mentioned above.

Further, since the process request comes in a short time in the section in which the encryption processes are requested at short intervals (RQSS), it is necessary to prevent the operation of the random number generator 240 by the random number amount and the exhaustion of the random numbers. In addition, the random numbers consumed in the section in which the encryption processes are requested at short intervals (RQSS) need to be generated during Tchange, which is the time until the next request.

The conditions to be satisfied by RNDmax and RNDth in the section in which the encryption processes are requested at short intervals (RQSS) are the following equations (7) and (8).

Treq(short)/Tperi(short)*RNDdelta<(RNDmax−RNDth(short)) (7)

Treq(short)/Tperi(short)*Trnddelta<Tchange (8)

In the section in which the encryption processes are requested at long intervals (RQLS), RNDmax and RNDth are adjusted under the condition satisfying the equations (4) and (6). Then, in the section in which the encryption processes are requested at short intervals (RQSS), RNDmax and RNDth are adjusted under the condition satisfying the equations (7) and (8). As a result, the CPU 100 can perform the encryption process without waiting for the random number generation time. Further, since the equations (7) and (8) include the performance of random number generation and the frequency of process requests, whether or not the performance of the secure IP 200 can satisfy the processing assumption of the CPU 100 is also determined together.

In the foregoing, the disclosure made by the discloser has been specifically described based on the embodiment and the examples, but it goes without saying that this disclosure is not limited to the embodiment and the examples described above and can be variously modified within the range not departing from the gist thereof.

What is claimed is:

1. A semiconductor device comprising:
a first control unit;
a second control unit;
a random number generator which can be accessed from the second control unit and cannot be accessed from the first control unit;
a first memory which can be accessed from the second control unit and cannot be accessed from the first control unit and in which random numbers generated by the random number generator are stored;
an encryption engine configured to perform encryption and decryption processes by using the random numbers stored in the first memory; and
a second memory which can be accessed from the second control unit and cannot be accessed from the first control unit and in which information related to random number generation is stored,
wherein the second control unit is configured to generate the random numbers by the random number generator based on the information related to random number generation.

2. The semiconductor device according to claim 1,
wherein the second control unit is configured to set the information related to random number generation to the second memory when there is a setting request for the information related to random number generation from the first control unit to the second memory and authentication is successful.

3. The semiconductor device according to claim 1,
wherein the second control unit is configured to request the random number generator to generate random numbers based on a usable random number amount stored in the first memory.

4. The semiconductor device according to claim 3,
wherein the information related to random number generation is a remaining random number amount at which the random number generation of the random number generator is started, and
wherein the second control unit is configured to request the random number generator to generate random numbers based on the usable random number amount stored in the first memory and the information related to random number generation.

5. The semiconductor device according to claim 3,
wherein the second control unit is configured to select whether to request the random number generator to generate random numbers by a request from the first control unit based on the information related to random number generation or to request the random number generator to generate random numbers based on the usable random number amount stored in the first memory.

6. The semiconductor device according to claim 3,
wherein the second control unit is configured to set a frequency of triggering the random number generator to generate random numbers and an operation time of the random number generator based on the information related to random number generation.

7. The semiconductor device according to claim 6,
wherein the information related to random number generation is a size of a region reserved for holding random numbers in the first memory and a remaining random number amount at which the random number generation of the random number generator is started.

8. The semiconductor device according to claim 2,
wherein the first control unit is composed of a first central processing unit and a third memory in which a program executed by the first central processing unit is stored, and
wherein the second control unit is composed of a second central processing unit and the second memory in which a program executed by the second central processing unit is stored.

9. A method for generating a random number comprising:
performing an encryption process using random numbers stored in a first memory in response to a request of the encryption process;
requesting a random number generator to generate random numbers based on information related to random number generation stored in a second memory; and
storing the random numbers generated by the random number generator in the first memory.

10. The method for generating the random number according to claim 9,
wherein the random numbers are generated by the random number generator based on a usable random number amount stored in the first memory and the information related to random number generation stored in the second memory.

11. The method for generating the random number according to claim 10,
wherein the information related to random number generation is a remaining random number amount at which the random number generation of the random number generator is started.

12. The method for generating the random number according to claim 10,
wherein the information related to random number generation is a size of a region reserved for holding random numbers in the first memory and a remaining random number amount at which the random number generation of the random number generator is started.

13. The method for generating the random number according to claim 9,
wherein the information related to random number generation is set to the second memory when there is a setting request for the information related to random number generation to the second memory and authentication is successful.
